(19) United States
(12) Patent Application Publication
(10) Pub. No.: US 2007/0188095 A1
(43) Pub. Date: Aug. 16, 2007

(54) PLANAR LIGHT SOURCE

(76) Inventors: Chu-Chi Ting, Hualien County (TW); Jau-Shiu Chen, Hsinchu City (TW); Yu-Heng Hsieh, Taipei City (TW); Chia-Yuan Chang, Nantou County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,621

(22) Filed: Feb. 15, 2006

(51) Int. Cl. H01J 17/00; H01J 1/62; H01J 63/04

(52) U.S. Cl. 313/581; 313/483; 313/484

(57) ABSTRACT

A planar light source is provided, and the planar light source includes a first plasma planar lamp and a second plasma planar lamp. The second plasma planar lamp is disposed on the first plasma planar lamp. The first and second plasma planar lamp have a plurality of bright regions and dark regions, respectively, wherein through allocating the bright regions and dark regions, the light emitted from the bright regions of the first plasma planar lamp is able to pass through the dark regions of the second plasma planar lamp. As mentioned above, the brightness of the planar light source can be improved.

### BACKGROUND OF THE INVENTION

1. Field of Invention

The present invention relates to a planar light source, and particularly to a planar light source using plasma display technique.

2. Description of the Related Art

As the need of the display increases, the thin film transistor liquid crystal display (TFT-LCD) with superior characteristics, such as high display quality, better efficiency for space usage, low power consumption, and no radiation, has become the main stream in the market. The thin film transistor liquid crystal display, for example, includes a liquid crystal display panel and a backlight module, wherein the liquid crystal display panel includes a thin film transistor array substrate, a color filter substrate and a liquid crystal layer disposed between the two substrates. In addition, the backlight module is used to provide the liquid crystal display panel with the needed planar light source so that the liquid crystal display can display.

Currently, the planar light source used by the backlight module usually employs a cold cathode fluorescent lamp (CCFL) as a linear light source, and then adopts a diffusion plate or a light-guide plate to provide a uniform planar light source. Therefore, another kind of the planar light source produced by the plasma display technique is developed. In detail, the planar light source is a plasma luminescing device, which imposes a high voltage difference between the electrode pair, so as to deionize the discharge gas between the cathode and the anode into plasma gas. The energy of the atoms under excited state in the plasma gas is released by emitting UV light, so as to excite the fluorescent powder to emit light.

FIG. 1A is a cross-sectional diagram of the conventional planar light source. FIG. 1B is a partial top view of the conventional planar light source. Referring to FIG. 1A and FIG. 1B, the conventional planar light source 100 includes a substrate 110, a plurality of electrode sets 120, a substrate 130, a frame 140, a plurality of spacers 150 and a fluorescent powder 160. The electrode sets 120 are disposed on the substrate 110, and the substrate 130 is disposed on the substrate 110. The frame 140 is disposed between the substrate 110 and the substrate 130, and the substrate 110, the substrate 130 and the frame 140 enclose a discharge chamber, wherein the discharge chamber is filled with discharge gas. The spacers 150 are disposed between the substrate 110 and the substrate 130 to separate the substrate 110 and the substrate 130. Besides, the fluorescent powder 160 is disposed on the substrate 110 and the substrate 130 to cover the electrode sets 120.

In detail, each of the electrode sets 120 includes sub-electrodes 122, 124 and 126, wherein the sub-electrode 122 has a plurality of discharge portions 122a toward the sub-electrode 124 and 126, respectively. In addition, the sub-electrodes 122, 124, and 126 are covered with a dielectric layer 120a, respectively. Moreover, all the sub-electrodes 124 and 126 are electrically coupled, and all the sub-electrodes 122 are also electrically coupled. Therefore, when the conventional planar light source 100 operates, the regions between the discharge portions 122a and the corresponding sub-electrode 124, and 126 are discharge regions. Therefore, the fluorescent powder within the discharge region is excited to luminesce. In other words, viewing from the exterior, a plurality of bright regions 100a and a plurality of dark region 100b will appear in the conventional planar light source 100. However, in order to reduce the influence of the bright regions 100a and the 100bdark regions, the conventional planar light source 100 usually needs to accompany with a diffusion plate (not shown), but the diffusion plate will reduce the brightness of the planar light source 100. If the driving current is increased in order to enhance the brightness of the planar light source 100, the life of the conventional planar light source 100 will be shortened.

### SUMMARY OF THE INVENTION

Accordingly, an object of the present invention is to provide a planar light source, so as to provide a uniform planar light source.

Based on the foregoing or other purposes, the present invention provides a planar light source, which includes a first plasma planar lamp and a second plasma planar lamp, wherein the second plasma planar lamp is disposed on the first plasma planar lamp. Each of the first plasma planar lamp and the second plasma planar lamp has a plurality of bright regions and a plurality of dark regions. Through allocating these bright regions and dark regions, the light emitted from the bright regions of the first plasma planar lamp is able to pass through the dark regions of the second plasma planar lamp.

According to an embodiment of the present invention, the locations of the bright regions of the first plasma planar lamp and the locations of the dark regions of the second plasma planar lamp can be overlapped.

According to an embodiment of the present invention, the shape of the bright regions and the dark regions is triangle.

According to an embodiment of the present invention, the shape of the bright regions and the dark regions is rectangle.

According to an embodiment of the present invention, each of the first plasma planar lamp and the second plasma planar lamp includes a first substrate, a plurality of electrode sets, a second substrate, a frame, a plurality of spacers and a fluorescent powder. The electrode sets are disposed on the first substrate and the second substrate is disposed on the first substrate. The frame is disposed between the second substrate and the first substrate, and the first substrate, the second substrate, and the frame enclose a discharge chamber, wherein the discharge chamber is filled with discharge gas. The spacers are disposed between the second substrate and the first substrate to separate the second substrate and the first substrate. The fluorescent powder is disposed on the locations of the bright regions of the first substrate and the second substrate.

According to an embodiment of the present invention, the second substrate of the first plasma planar lamp can be further used as the first substrate of the second plasma planar lamp.

According to an embodiment of the present invention, the fluorescent powder of the first plasma planar lamp can be further disposed on the locations of the dark regions of the first substrate and the second substrate.

According to an embodiment of the present invention, the shape of the spacers can be a strip.

According to an embodiment of the present invention, each of the electrode sets includes a first sub-electrode, a second sub-electrode, a third sub-electrode and a fourth sub-electrode, wherein the first sub-electrode has a plurality of first discharge portions. The second sub-electrode has a plurality of second discharge portions toward the first sub-electrode, and the first discharge portions are toward the second sub-electrode. The third sub-electrode is disposed between the first sub-electrode and the second sub-electrode, and the first sub-electrode, the second sub-electrode and the third sub-electrode are arranged in parallel.

According to an embodiment of the present invention, the third sub-electrode of each of the electrode sets can have a plurality of third discharge portions toward the first sub-electrode and the second sub-electrode, respectively.

According to an embodiment of the present invention, each of the electrode sets can further have a fourth sub-electrode disposed between the third sub-electrode and the second sub-electrode, wherein the first sub-electrode, the second sub-electrode, the third sub-electrode and the fourth sub-electrode are arranged in parallel. Besides, the third sub-electrode of each of the electrode sets can have a plurality of third discharge portions toward the first sub-electrode and the fourth sub-electrode of each of the electrode sets can have a plurality of fourth discharge portions toward the second sub-electrode.

According to an embodiment of the present invention, each of the electrode sets include a first sub-electrode, second sub-electrode and a third sub-electrode, wherein the first sub-electrode has a plurality of first discharge portions, and the first sub-electrode is disposed between the second sub-electrode and the third sub-electrode. The first discharge portions are toward the second sub-electrode and the third sub-electrode, respectively, and the first sub-electrode, the second sub-electrode and the third sub-electrode are arranged in parallel.

The second sub-electrode of each of the above-described electrode sets can have a plurality of second discharge portions toward the first sub-electrode and the third sub-electrode of each of the electrode sets can have a plurality of third discharge portions toward the first sub-electrode.

According to an embodiment of the present invention, the discharge gas can be selected from one of the xenon (Xe), neon (Ne), argon (Ar) and the combination thereof.

Accordingly, the invention adopts the stack of two plasma planar lamps, wherein the light emitting from the lower plasma planar lamp can pass through the dark regions of the upper plasma planar lamp. Therefore, the planar light source in the present invention can provide uniform planar light source.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a cross-sectional diagram illustrating a conventional planar light source.

FIG. 1B is a partial top view of a conventional planar light source.

FIG. 2A is a cross-sectional diagram illustrating a planar light source according to the first embodiment of the present invention.

FIG. 2B is a partial top view of the first plasma planar lamp in FIG. 2A.

FIG. 2C is a partial top view of the second plasma planar lamp in FIG. 2A.

FIG. 3A is a partial top view of a first plasma planar lamp according to the second embodiment of the present invention.

FIG. 3B is a partial top view of a second plasma planar lamp according to the second embodiment of the present invention.

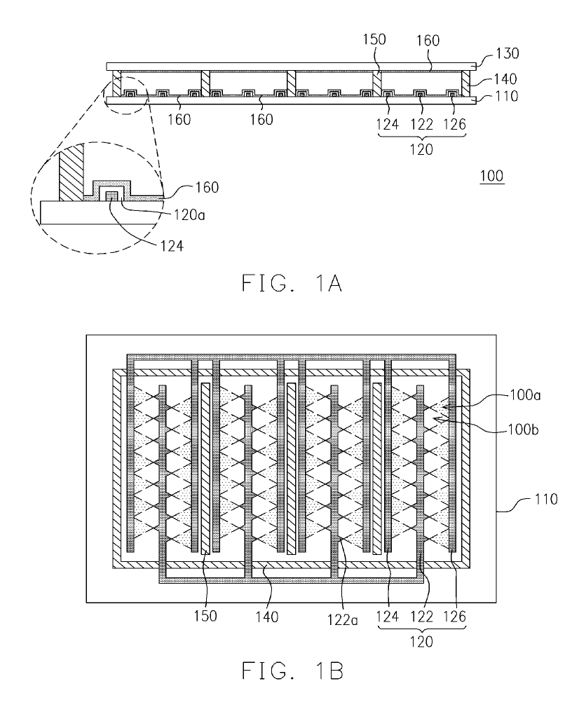

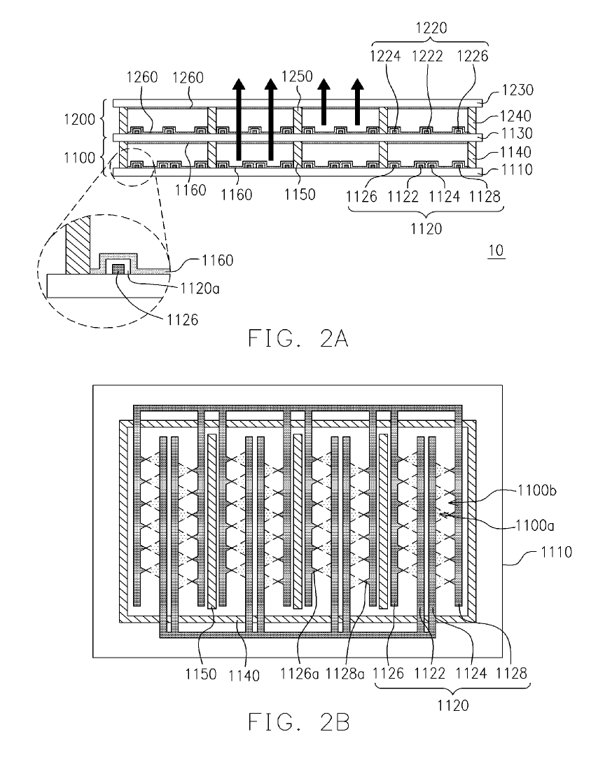

### DESCRIPTION OF THE EMBODIMENTS

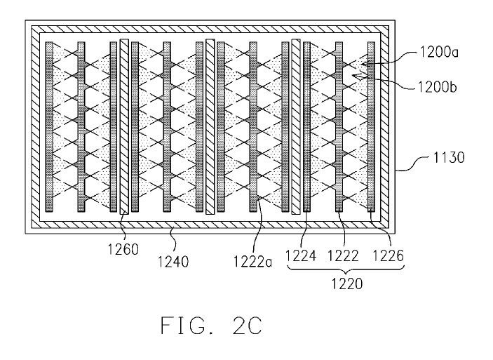

FIG. 2A is a cross-sectional diagram illustrating a planar light source according to the first embodiment of the present invention. FIG. 2B is a partial top view of the first plasma planar lamp in FIG. 2A. FIG. 2C is a partial top view of the second plasma planar lamp in FIG. 2A. Referring to FIG. 2A first, the planar light source 10 in the present embodiment includes a first plasma planar lamp 1100 and a second plasma planar lamp 1200, wherein the second plasma planar lamp 1200 is disposed on the first plasma planar lamp 1100, and the light emitting from the first plasma planar lamp 1100 passes through the dark regions 1200b of the second plasma planar lamp 1200. Therefore, the planar light source 10 can provide uniform planar light source.

Referring to FIG. 2A and FIG. 2B, the first plasma planar lamp 1100 includes a substrate 1110, a plurality of electrode sets 1120, a substrate 1130, a frame 1140, a plurality of spacers 1150 and a fluorescent powder 1160. The electrode sets 1120 are disposed on the substrate 1110 and the substrate 1130 is disposed on the substrate 1110. The frame 1140 is disposed between the substrate 1110 and the substrate 1130, and the substrate 1110, the substrate 1130 and the frame 1140 enclose a discharge chamber, wherein the discharge chamber is filled with discharge gas. The discharge gas can be xenon (Xe), neon (Ne), argon (Ar), or the combination thereof. The spacers 1150 are disposed between the substrate 1110 and the substrate 1130, and the spacers 1150 can be used to separate the electrode sets 1120, wherein the shape of the spacer 1150 can be strip, pillar, or other kinds of shapes. In addition, the fluorescent powder 1160 is disposed on the substrate 1110 and the substrate 1130. For example, the fluorescent powder 1160 can be disposed on the bright regions 1100a and the dark regions 1100b of the substrate 1110 or the substrate 1130. However, the fluorescent powder 1160 can be disposed only on the locations of the bright regions 1100a of the substrate 1110 and/or the substrate 1130.

In detail, each of the electrode sets 1120 includes sub-electrodes 1122, 1124, 1126 and 1128, wherein the sub-electrodes 1122, 1124, 1126 and 1128 can be arranged in parallel. Besides, the sub-electrodes 1122, 1124, 1126 and 1128 are covered with a dielectric layer 1120a. All the sub-electrodes 1122 and 1124 are electrically coupled and all the sub-electrodes 1126 and 1128 are also electrically coupled. Moreover, the sub-electrode 1126 has a plurality of discharge portions 1126a toward the sub-electrode 1122, respectively, and the sub-electrode 1128 has a plurality of discharge portions 1128a toward the sub-electrode 1124. Therefore, the region between the discharge portions 1126a and the sub-electrode 1122, and between the discharge portions 1128a and the sub-electrode 1124 can be divided into a plurality of triangular bright regions 1100a and a plurality of triangular dark regions 1100b. However, the shape of the bright regions 1100a and the dark regions 1100b is not limited to triangle. The shape of the bright regions 1100a and the dark regions 1100b depends on the pattern of the sub-electrode in each of the electrode sets 1120. Accordingly, the sub-electrodes 1122 and 1124 can be integrated together.

Referring to FIG. 2A and FIG. 2C, the second plasma planar lamp 1200 is similar to the first plasma planar lamp 1100, and the second plasma planar lamp 1200 also includes a substrate 1130, a plurality of electrode sets 1220, a substrate 1230, a frame 1240, a plurality of spacers 1250 and a fluorescent powder 1260. The electrode sets 1220 are disposed on the substrate 1130, and the substrate 1230 is disposed on the substrate 1130. The frame 1240 is disposed between the substrate 1130 and the substrate 1230, and the substrate 1130, the substrate 1230 and the frame 1240 enclose a discharge chamber, wherein the discharge chamber is filled with discharge gas. The spacers 1250 are disposed between the substrate 1130 and the substrate 1230 to separate the substrate 1130 and the substrate 1230. The spacers 1250 can be used to separate the electrode sets 1220, wherein the shape of the spacers 1250 can be strip, pillar, or other kinds of shapes. Accordingly, the substrate 1130 is not only a part of the first plasma planar lamp 1100, but also a part of the second plasma planar lamp 1200. In other words, the substrate 1130 is commonly used by the first plasma planar lamp 1100 and the second plasma planar lamp 1200. However, the first plasma planar lamp 1100 and the second plasma planar lamp 1200 can be individually independent.

Each of the electrode sets 1220 include sub-electrodes 1222, 1224 and 1226, wherein the sub-electrodes 1222, 1224 and 1226 can be arranged in parallel. Besides, the sub-electrode 1222 has a plurality of discharge portions 1222a toward sub-electrodes 1224 and 1226, respectively. Therefore, by viewing from the exterior, the second plasma planar lamp 1200 has a plurality of triangular bright regions 1200a and triangular dark regions 1200b. In addition, the fluorescent powder 1260 is disposed on the corresponding bright regions 1200a of the substrate 1130 and/or the substrate 1230. However, the fluorescent powder 1260 can be also disposed on the dark regions 1200b of the substrate 1130 or the substrate 1230 simultaneously.

In the present embodiment, the locations of the bright regions 1100a of the first plasma planar lamp 1100 and the locations of the dark regions 1200b of the second plasma planar lamp 1200 can be overlapped. Therefore, the light emitting from the bright regions 1100a of the first plasma planar lamp 1100 can pass through the dark regions 1200b of the second plasma planar lamp 1200. In other words, the planar light source 10 in the present embodiment not only can provide uniform planar light source, but also have higher brightness. Besides, in the requirements of the same brightness and uniformity, the driving current needed for the first plasma planar lamp 1100 and the second plasma planar lamp 1200 is smaller. Therefore, the planar light source 10 in the present embodiment has longer life.

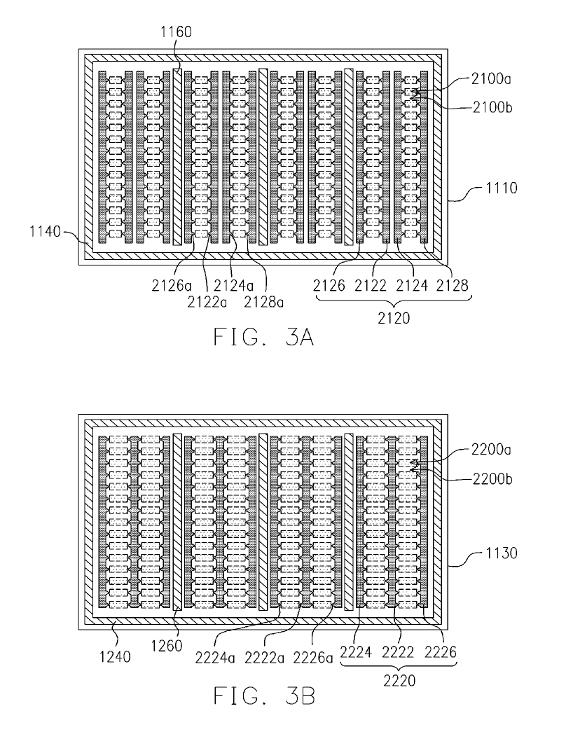

FIG. 3A is a partial top view of a first plasma planar lamp according to the second embodiment of the present invention. FIG. 3B is a partial top view of a second plasma planar lamp according to the second embodiment of the present invention. Referring to FIG. 3A first, the present embodiment is similar to the foregoing embodiment. The difference is: each of the electrode sets 2120 includes sub-electrodes 2122, 2124, 2126 and 2128, wherein the sub-electrodes 2122, 2124, 2126 and 2128 can be arranged in parallel. The sub-electrode 2126 has a plurality of discharge portions 2126a and the sub-electrode 2122 also has a plurality of discharge portions 2122a, wherein the discharge portions 2126a and the discharge portions 2122a corresponds to each other. In other words, the region between the sub-electrodes 2126 and 2122 can be divided into a plurality rectangular bright regions 2100a and rectangular dark regions 2100b.

Similarly, the sub-electrode 2124 has a plurality of discharge portions 2124a and the sub-electrode 2128 also has a plurality of discharge portions 2128a, wherein the discharge portions 2124a and the discharge portions 2128a corresponds to each other, and the region between the sub-electrodes 2124 and 2128 can be divided into a plurality rectangular bright regions 2100a and rectangular dark regions 2100b. Besides, the sub-electrodes 2122 and 2124 can be integrated together (similar to the sub-electrode 2222).

Referring to FIG. 3B, each of the electrode sets 2220 include sub-electrodes 2222, 2224 and 2226, wherein the sub-electrodes 2222, 2224 and 2226 can be arranged in parallel. The sub-electrode 2222 has a plurality of discharge portions 2222a toward the sub-electrodes 2224 and 2226, respectively. Besides, the sub-electrode 2224 also has a plurality of discharge portions 2224a and the sub-electrode 2226 also has a plurality of discharge portions 2226a, wherein parts of the discharge portion 2222a and the discharge portions 2224a corresponds to each other and other parts of the discharge portions 2222a and the discharge portions 2226a corresponds to each other. Therefore, the region between the sub-electrodes 2226 and 2222 and between the sub-electrodes 2224 and 2222 can be divided into a plurality of rectangular bright regions 2200a and rectangular dark regions 2200b. Because the locations of the rectangular dark regions 2200b and rectangular bright regions 2100a are overlapped, the light emitting from the bright regions 2100a of the lower first plasma planar lamp can pass through the dark regions 2200b of the second plasma planar lamp to provide uniform planar light source.

To sum up, the planar light source in the present invention at least has following advantages:

1. Because the light emitting from the bright regions of the lower plasma planar lamp can pass through the dark regions of the upper plasma planar lamp, the planar light source in the present invention not only can provide uniform planar light source, but has a higher brightness.

2. Compared to the conventional technique, the first plasma planar lamp and the second plasma planar lamp in the present invention need smaller driving current. Therefore, the planar light source in the present invention has longer life.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A planar light source comprising:
a first plasma planar lamp; and
a second plasma planar lamp disposed on the first plasma planar lamp, and each of the first and the second plasma planar lamp has a plurality of bright regions and a plurality of dark regions, wherein through allocating the bright regions and dark regions, the light emitted from the bright regions of the first plasma planar lamp is able to pass through the dark regions of the second plasma planar lamp.

2. The planar light source as recited in claim 1, wherein the locations of the bright regions of the first plasma planar lamp are overlapped with the locations of the dark regions of the second plasma planar lamp.

3. The planar light source as recited in claim 1, wherein the shape of the bright regions and the dark regions is triangle.

4. The planar light source as recited in claim 1, wherein the shape of the bright regions and the dark regions is rectangle.

5. The planar light source as recited in claim 1, wherein each of the first plasma planar lamp and the second plasma planar lamp comprises:
a first substrate;
a plurality of electrode sets disposed on the first substrate;
a second substrate disposed on the first substrate;
a frame disposed between the second substrate, and the first substrate, and the first substrate, the second substrate, and the frame enclose a discharge chamber, wherein the discharge chamber is filled with discharge gas;
a plurality of spacers disposed between the second substrate and the first substrate to separate the second substrate and the first substrate; and
a fluorescent powder disposed on the locations of the bright regions of the first substrate and the second substrate.

6. The planar light source as recited in claim 5, wherein the second substrate of the first plasma planar lamp is further used as the first substrate of the second plasma planar lamp.

7. The planar light source as recited in claim 5, wherein the fluorescent powder of the first plasma planar lamp is further disposed on the locations of the dark regions of the first substrate and the second substrate.

8. The planar light source as recited in claim 5, wherein the spacers are used to separate the electrode sets.

9. The planar light source as recited in claim 8, wherein the shape of the spacers comprises strip.

10. The planar light source as recited in claim 5, wherein each of the electrode sets comprises:
a first sub-electrode having a plurality of first discharge portions;
a second sub-electrode having a plurality of second discharge portions toward the first sub-electrode, and the first discharge portions are toward the second sub-electrode; and
a third sub-electrode disposed between the first sub-electrode and the second sub-electrode, wherein the first sub-electrode, the second sub-electrode and the third sub-electrode are arranged in parallel.

11. The planar light source as recited in claim 10, wherein the third sub-electrode of each electrode sets has a plurality of third discharge portions toward the first sub-electrode and the second sub-electrode, respectively.

12. The planar light source as recited in claim 10, wherein each of the electrode sets further comprises a fourth sub-electrode disposed between the third sub-electrode and the second sub-electrode, wherein the first sub-electrode, the second sub-electrode, the third sub-electrode and the fourth sub-electrode are arranged in parallel.

13. The planar light source as recited in claim 12, wherein the third sub-electrode of each of the electrode sets has a plurality of third discharge portions toward the first sub-electrode, and the fourth sub-electrode of each of the electrode sets has a plurality of fourth discharge portions toward the second sub-electrode.

14. The planar light source as recited in claim 5, wherein each of the electrode sets comprises:
a first sub-electrode having a plurality of first discharge portions;
a second sub-electrode; and
a third sub-electrode, and the first sub-electrode disposed between the second sub-electrode and the third sub-electrode, wherein the first discharge portions are toward the second sub-electrode and the third sub-electrode, respectively, and the first sub-electrode, the second sub-electrode and the third sub-electrode are arranged in parallel.

15. The planar light source as recited in claim 14, wherein the second sub-electrode of each of the electrode sets has a plurality of second discharge portions toward the first sub-electrode, and the third sub-electrode of each of the electrode sets has a plurality of third discharge portions toward the first sub-electrode.

16. The planar light source as recited in claim 5, wherein the discharge gas is selected from one of the xenon (Xe), neon (Ne), argon (Ar) and the combination thereof.
